(19) United States
(12) Patent Application Publication
(10) Pub. No.: US 2013/0321527 A1
(43) Pub. Date: Dec. 5, 2013

(54) INK CLEANING APPARATUS FOR PRINTERS

(71) Applicant: HON HAI PRECISION INDUSTRY CO., LTD., New Taipei (TW)

(72) Inventor: KUNG-HUANG TSAI, New Taipei (TW)

(73) Assignee: HON HAI PRECISION INDUSTRY CO., LTD., New Taipei (TW)

(21) Appl. No.: 13/849,645

(22) Filed: Mar. 25, 2013

(30) Foreign Application Priority Data
Jun. 4, 2012 (TW) 101119895

(51) Int. Cl. B41J 2/165

(52) U.S. Cl. CPC B41J 2/16538
USPC 347/33

(57) ABSTRACT

An ink cleaning apparatus for a printer, includes a case and a cleaning arm. The case is adapted to slide on a shaft. The cleaning arm is movably mounted on the case. The brush is pivotally mounted on the cleaning arm. The brush includes a cleaning portion. The cleaning arm is adapted to move out of the case with the brush located above the shaft. The cleaning portion is engaged with the shaft by rotating the brush. The cleaning portion is configured to clean the shaft by sliding the case on the shaft.

### BACKGROUND

1. Technical Field

The present disclosure relates to cleaning apparatuses, and more particularly to an ink cleaning apparatus for cleaning ink in a printer.

2. Description of Related Art

An ink-jet printer is designed to print by injecting ink while moving an ink cartridge on a shaft. The ink cartridge has a bottom surface mounted with a head for spraying the ink. The head has nozzles to spray the ink. While the nozzles inject the ink on the printing medium, some ink may splatter in the printer and contaminate the shaft. Ink accumulated on the shaft may hinder the movement of the ink cartridge on the shaft.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partially exploded and isometric view of an embodiment of an ink cleaning apparatus for a printer.

FIG. 2 is an exploded and isometric view of an embodiment of an ink cleaning apparatus for a printer.

FIG. 3 is an isometric view of a cleaning arm of the ink cleaning apparatus of FIG. 1.

FIG. 4 is an assembled view of the cleaning apparatus of FIG. 1.

FIG. 5 is another assembled view of the cleaning apparatus of FIG. 1.

FIG. 6 is another assembled view of the cleaning apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

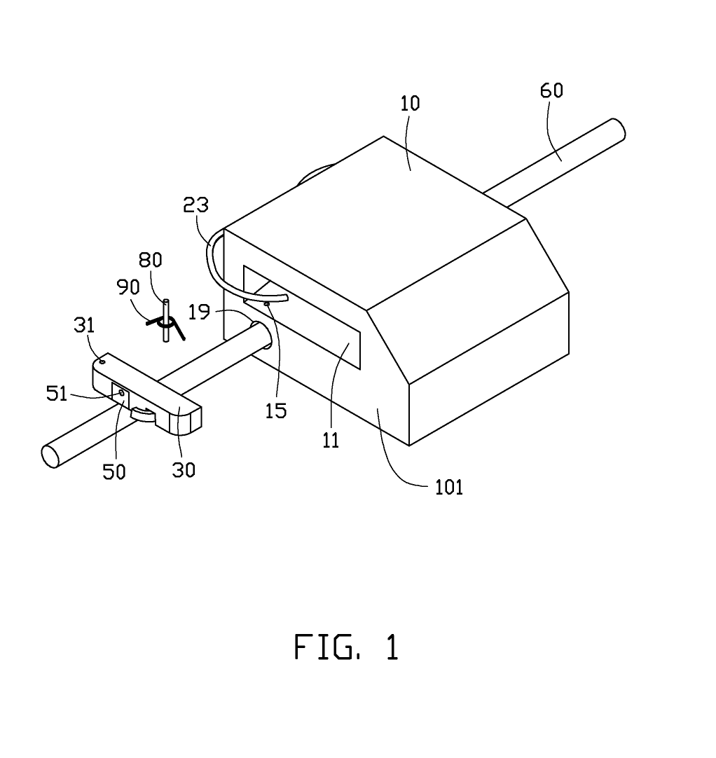

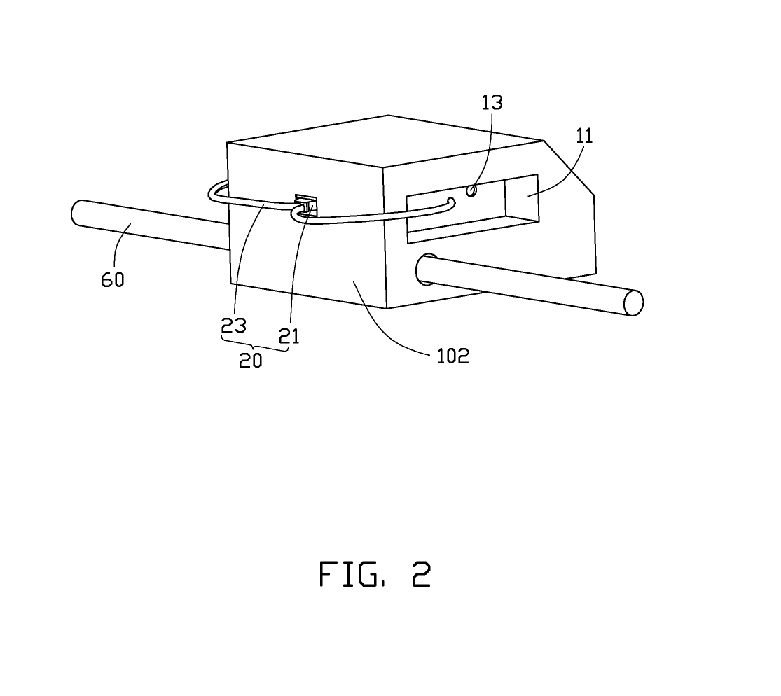

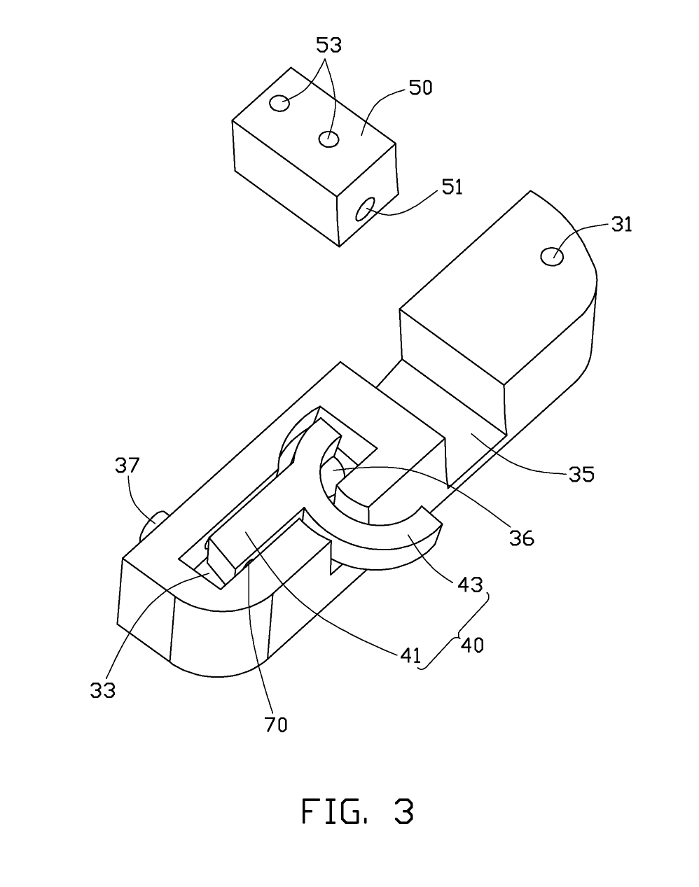

FIGS. 1 to 3 show an ink cleaning apparatus in accordance with one embodiment. The ink cleaning apparatus includes a case 10, a gas outputting apparatus 20, and two cleaning arms 30 pivotally mounted on the case 10. The ink cleaning apparatus is used to clean oil on a shaft 60, which is located in a printer.

The case 10 includes a pair of side walls 101 and a rear wall 102. A through hole 19 extends through the case 10 and is located between the pair of side walls 101. Each side wall 101 defines a receiving space 11 which is adapted to receive the cleaning arm 30. A pair of pivot holes 15 and a mounting hole 13 is defined in the receiving space 11.

The gas outputting apparatus 20 includes a high pressure gas generating device 21 and a pair of gas pipes 23 connected to the high pressure gas generating device 21. The high pressure gas generating device 21 is mounted on the rear wall 102 of the case 10.

The cleaning arm 30 includes a receiving hole 31, a receiving groove 33, and a slot 35. The slot 35 is located between the receiving hole 31 and the receiving groove 33. A brush 40 is mounted in the receiving groove 33. The brush 40 includes a pole 41 and a semicircular cleaning portion 43 connected to the pole 41. The pole 41 is pivotally mounted in the receiving groove 33 via a pin 70. An electromagnet 36 is located in the receiving groove 33. The brush 40 is made of magnetic material. When the electromagnet 36 is turned on, a magnetic force is generated to retract the brush 40. If the electromagnet 36 is turned off, no magnetic force is generated and the brush 40 is not retracted. A side of cleaning arm 30 includes a mounting post 37 corresponding to the mounting hole 13 of the case 10. The mounting post 37 can be releasably inserted in the mounting hole 13.

A pole 80 is adapted to be received in the receiving hole 31. A torsion spring 90 is adapted to be located on the pole 80.

A lubricant storage box 50 is adapted to be mounted in the slot 35 of the cleaning arm 30. The lubricant storage box 50 stores lubricant. The lubricant storage box 50 includes a gas hole 51 and two leaking holes 53.

FIGS. 1 to 4 show that in assembly, the lubricant storage box 50 is mounted in the slot 35 of the cleaning arm 30. The pole 80 is inserted in the receiving hole 31 of the cleaning arm 30. The torsion spring 90 is located on the pole 80. Opposite ends of the pole 80 are inserted in the pair of pivot holes 15 to pivotally mount the cleaning arm 30 on the case 10. The torsion spring 90 is resisted between the cleaning arm 30 and the case 10. Then, the cleaning arm 30 rotates around the pole 80 and into the receiving space 11. The torsion spring 90 is elastically deformed. The mounting post 37 is inserted in the mounting hole 13 to retain the cleaning arm 30 in the receiving space 11. At last, the gap pipe 23 is inserted in the gas hole 51 of the lubricant storage box 50. Therefore, the ink cleaning apparatus is assembled.

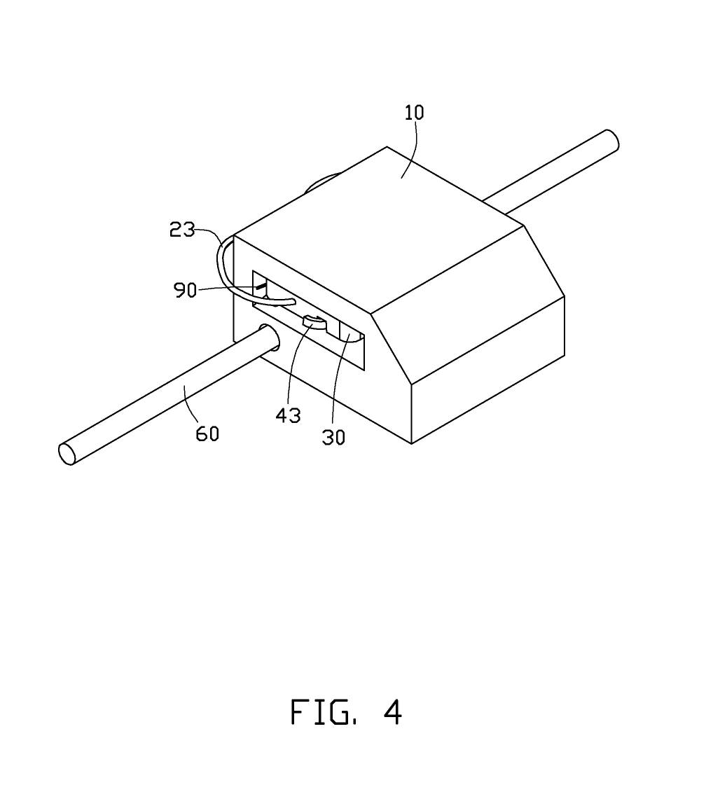

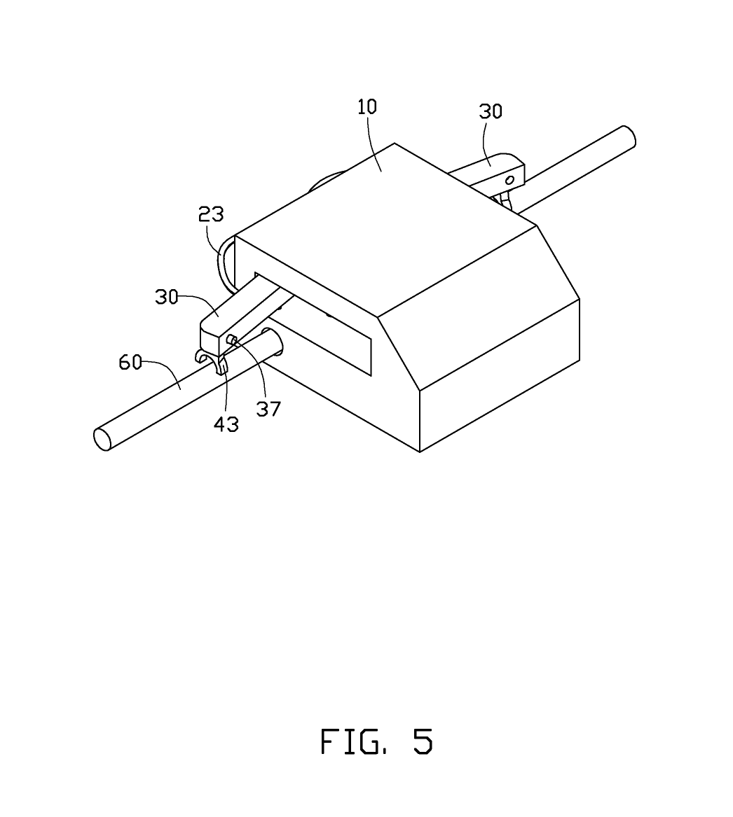

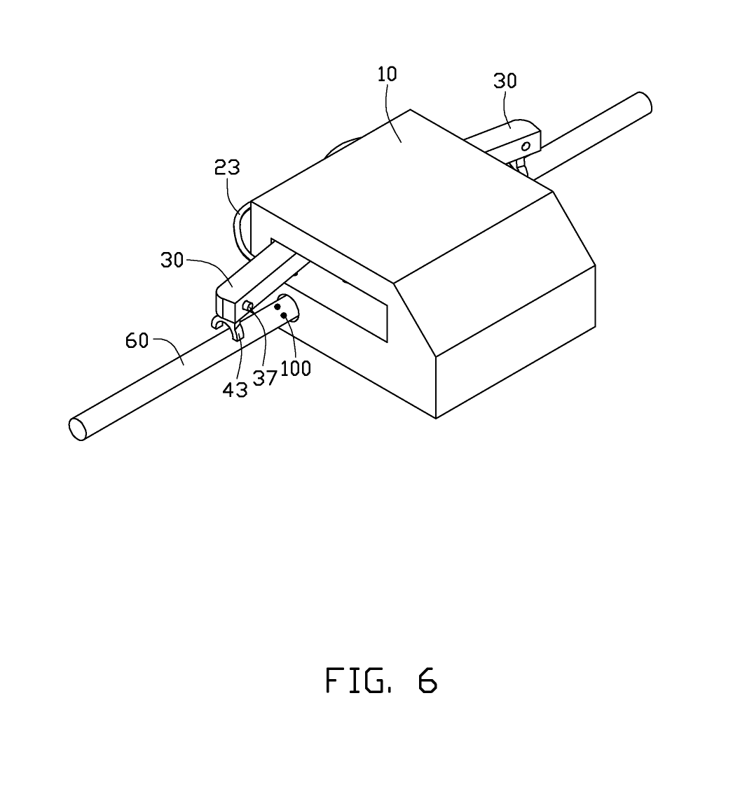

FIGS. 4 to 6 show that after the printer has printed a number of papers, such as 300 pieces of papers, and a plurality of inks accumulated on the shaft 60, the ink cleaning apparatus starts to work. The case 10 slides on the shaft 60 to have the cleaning arm 30 knock an inner side of the printer to loosen the mounting post 37 in the mounting hole 31. The cleaning arm 30 rotates out of the receiving space 11 by a spring force of the torsion spring 90. At this position, the brush 40 is located above the shaft 60. Then, the electromagnet 36 is turned off to release the brush 40. The brush 40 drops from the receiving groove 33 with the cleaning portion 43 engaging with the shaft 60. Next, the case 10 reciprocate on the shaft 60 to clean oil 100 (shown in FIG. 6) from the shaft 60. In succession, the high pressure gas generating device 21 generates high pressure gas and supplies the high pressure gas into the lubricant storage box 50 via the gap pipe 23. Lubricant leaks out of the lubricant storage box 50 via the leaking holes 53 because of the high pressure gas. Lubricant drops on the shaft 60. The case 10 reciprocates on the shaft 60 again to have the cleaning portion 43 daubing the lubricant on the shaft 60 to maintain the shaft 60. Therefore, the shaft 60 can be completely clean.

Subsequently, the electromagnet 36 is turned on to retract the brush 40 in the receiving groove 33. The case 10 slides on the shaft 60 to have the cleaning arm 30 knock an inner side of the printer to insert the mounting post 37 in the mounting hole 31. Reverting the ink cleaning apparatus to the first position.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An ink cleaning apparatus for a printer, comprising:
a case configured to slide on a shaft;
a cleaning arm movably mounted on the case, a brush pivotally mounted on the cleaning arm, the brush comprising a cleaning portion;
wherein the cleaning arm is configured to move out of the case with the brush located above the shaft, the cleaning portion is engaged with the shaft by rotating the brush, and the cleaning portion is configured to clean the shaft by sliding the case on to the shaft.

2. The ink cleaning apparatus of claim 1, wherein the cleaning portion is formed on a semicircle.

3. The ink cleaning apparatus of claim 1, wherein the cleaning arm defines a receiving groove, and the cleaning arm is received in the receiving groove.

4. The ink cleaning apparatus of claim 3, wherein the cleaning arm comprises a pole connected to the cleaning portion, and the pole is pivotally mounted in the receiving groove via a pin.

5. The ink cleaning apparatus of claim 3, wherein an electromagnet is located in the receiving groove, the brush is made of magnetic material, the brush is attached to the electromagnet by turning on the electromagnet to generate magnetic forces.

6. The ink cleaning apparatus of claim 1, wherein a lubricant storage box is mounted on the cleaning arm, the lubricant storage box stores lubricant therein, and the lubricant storage box is adapted to drop the lubricant on the shaft after the shaft is cleaned by the cleaning portion.

7. The ink cleaning apparatus of claim 6, wherein the lubricant storage box comprises a leaking hole configured to drop lubricant on the shaft.

8. The ink cleaning apparatus of claim 7, wherein the lubricant storage box comprises a gas hole, a high pressure gas generating apparatus is connected to the gas hole via a gas pipe, and the high pressure gas generating apparatus is adapted to generate high pressure gas and to transmit the high pressure gas into the lubricant storage box via the gas pipe to urge the lubricant dropping from the leaking hole.

9. The ink cleaning apparatus of claim 1, wherein the cleaning arm is pivotally mounted on the case by a pole, a torison spring is located on the pole and resisting between the case and the cleaning arm.

10. The ink cleaning apparatus of claim 1, wherein the case defines a mounting hole, the cleaning arm comprises a mounting post, and the mounting post is detachably inserted in the mounting hole.

11. An ink cleaning apparatus for a printer, comprising:
a case configured to slide on a shaft;
a cleaning arm movably mounted on the case, a lubricant storage box mounted on the cleaning arm, the lubricant storage box being configured to store lubricant, the lubricant storage box comprising a gas hole and a leaking hole; and
a high pressure gas generating apparatus connected to the gas hole via a gas pipe;
wherein the high pressure gas generating apparatus is adapted to generate high pressure gas and to transmit the high pressure gas into the lubricant storage box via the gas pipe to urge the lubricant dropping from the leaking hole and on the shaft, and the case is adapted to slide on the shaft to daub the lubricant on the shaft.

12. The ink cleaning apparatus of claim 11, wherein a brush is pivotally mounted on the cleaning arm, the brush comprises a cleaning portion, the cleaning portion is engaged with the shaft by rotating the brush, and the cleaning portion is configured to clean the shaft when the case is slide on to the shaft.

13. The ink cleaning apparatus of claim 12, wherein the cleaning portion is formed on a semicircle.

14. The ink cleaning apparatus of claim 12, wherein the cleaning arm defines a receiving groove, and the cleaning arm is received in the receiving groove.

15. The ink cleaning apparatus of claim 14, wherein the cleaning arm comprises a pole connected to the cleaning portion, and the pole is pivotally mounted in the receiving groove via a pin.

16. The ink cleaning apparatus of claim 14, wherein an electromagnet is located in the receiving groove, the brush is made of magnetic material, the electromagnet is adapted to be turned on to generate magnetic force to attach the brush thereon.

17. The ink cleaning apparatus of claim 12, wherein the cleaning arm is pivotally mounted on the case by a pole, a torison spring is located on the pole and resisting between the case and the cleaning arm.

18. The ink cleaning apparatus of claim 12, wherein the case defines a mounting hole, the cleaning arm comprises a mounting post, and the mounting post is detachably inserted in the mounting hole.
